(19) United States
(12) Patent Application Publication
(10) Pub. No.: US 2019/0105848 A1
(43) Pub. Date: Apr. 11, 2019

(54) Process for spraying back-adhesive on CMP pad

(71) Applicant: Chengdu Times Live Science and Technology Co.Ltd., Chengdu (CN)

(72) Inventors: Xueyan Zhang, Chengdu (CN); Lijuan Zhang, Chengdu (CN)

(73) Assignee: Chengdu Times Live Science and Technology Co.Ltd.

(21) Appl. No.: 16/215,335

(22) Filed: Dec. 10, 2018

(30) Foreign Application Priority Data
Jul. 26, 2018 (CN) 201810833918.2

(51) Int. Cl. B29C 65/52; B24B 37/20

(52) U.S. Cl. CPC B29C 65/522; B29L 2031/736; B24B 37/20

(57) ABSTRACT

A process for spraying back-adhesive of a CMP pad, includes steps of: horizontally placing an underlayment on middle portions of an upper conveying roller and a lower conveying roller of a hot melt machine for feeding; providing an upper layer glue-coated paper closely attached with an upper surface of the underlayment on the upper conveying roller, providing a lower layer glue-coated paper closely attached with a lower surface of the underlayment on the lower conveying roller; spraying hot melt adhesive on an upper surface of the lower layer glue-coated paper via an ejector nozzle of the hot melt machine; wherein the upper layer glue-coated paper, the underlayment and the lower layer glue-coated paper are transmitted and adhered with each other on the upper conveying roller and the lower conveying roller.

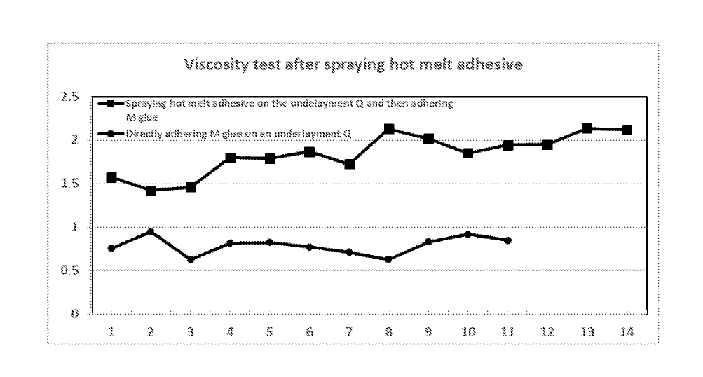

### CROSS REFERENCE OF RELATED APPLICATION

The present application claims priority under 35 U.S.C. 119(a-d) to CN 201810833918.2, filed Jul. 26, 2018.

### BACKGROUND OF THE PRESENT INVENTION

### Field of Invention

The present invention relates to the technical filed of chemical mechanical polishing (CMP) pad manufacturing, and more particularly to a process for spraying back-adhesive on a CMP pad.

### Description of Related Arts

Chemical mechanical polishing (CMP) is a micro-nano processing technology that combines mechanical grinding and chemical oxidation to remove the surface material of the workpiece to be processed. The CMP technology is capable of making the surface of the workpiece to be ultra-flat and ultra-smooth and is mainly applied in the field of IC and MEMS manufacturing. The polishing process is a combination of chemical etching and mechanical friction, wherein the workpiece is fixed on the face-down grinding head and fixed on the rotating table. The surface of the rotating table is covered with a polishing pad, and the abrasive slurry with small abrasive particles flows onto the table. The surface material of the workpiece is invaded by the abrasive particles and is grinded off little by little and then washed away by the abrasive slurry. The surface of the workpiece is polished due to the rotational frictions of the two rails and the combined action of the abrasive slurry. Polishing pads play a very important role in the CMP process. Thus, large quantity of research work has been done on the properties of polishing pads and their effects on the CMP process. Polyurethane polishing pads are widely applied in the field of chemical polishing and mechanical polishing due to their excellent properties.

At present, the main structure of the polyurethane polishing pad is divided into a substrate, an underlayment and a back adhesive, wherein one side of the substrate and the underlayment are adhered by a double-sided tape, and the back adhesive is directly adhered to the other side of the underlayment by glue. In addition, the outer layer of the adhesive is provided with a release film, and the release film is tear out during utilization, and the polishing pad is directly attached to the machine table. However, the adhesion between the conventional underlayment of the polishing pad and the back adhesive is not stable. In actual use, the machine adhered with the polishing pad is rotated at a high speed and during the rotation process, the back adhesive is not steadily adhered on the underlayment, and water seepage problems exist in the polishing pad. The moisture in the polishing solution penetrates between the underlayment and the back adhesive. In the long run, the underlayment will be separated from the back adhesive and the penetration of the polishing liquid, and there is a risk that the polishing pad will be separated from the machine table. The problems seriously affect the polishing process and reduce the product yield.

### SUMMARY OF THE PRESENT INVENTION

In view of the problems mentioned above, an object of the present invention is to provide a process for spraying a back-adhesive on CMP polishing pad, so as to solve the problems in the conventional spraying processes that back adhesive and underlayment of the polishing pad obtained is unstable in viscosity, the polishing pad is water-permeable, and permeating slurry and the machine are separated, so as to ensure normal operation and qualified rate of products during the polishing process.

A process for spraying back-adhesive of a CMP pad, comprises following steps of: horizontally placing an underlayment on middle portions of an upper conveying roller and a lower conveying roller of a hot melt machine for feeding; providing an upper layer glue-coated paper closely attached with an upper surface of the underlayment on the upper conveying roller, providing a lower layer glue-coated paper closely attached with a lower surface of the underlayment on the lower conveying roller; spraying hot melt adhesive on an upper surface of the lower layer glue-coated paper via an ejector nozzle of the hot melt machine; wherein the upper layer glue-coated paper, the underlayment and the lower layer glue-coated paper are transmitted and adhered with each other on the upper conveying roller and the lower conveying roller.

Preferably, a type of the hot melt machine mentioned above is JYT110; wherein the upper conveying roller and the lower conveying roller are provided along a vertical direction from top to bottom, the upper conveying roller and the lower conveying roller are cooperated with each other for serving as a conveying belt; the underlayment is horizontally provided between the upper conveying roller and the lower conveying roller for conveying; wherein the upper layer glue-coated paper is closely adhered with the upper layer of the underlayment, and the lower layer glue-coated paper is closely adhered with the lower layer of the underlayment; the underlayment, the upper layer glue-coated paper and the lower layer glue-coated paper are conveyed along an identical direction.

Furthermore, a width of the upper layer glue-coated paper and a width of the lower layer glue-coated paper are both greater than a width of the ejector nozzle, and the width of the ejector nozzle is greater than a width of the underlayment. The width of the ejector nozzle is greater than the width of the underlayment, which makes a width of hot melt adhesive on the lower layer glue-coated paper greater than a width of the underlayment, in such a manner that the underlayment is fully adhered with the lower layer glue-coated paper. In addition, since hot melt adhesive still exists on both sides of the underlayment after that the lower layer glue-coated paper and the underlayment are adhered with each other, the upper layer glue-coated paper is adhered with the lower layer glue-coated paper, so as to prevent the upper surface of the lower layer glue-coated paper from adhering with the upper conveying roller. Furthermore, the upper layer glue-coated paper has an insulating effect to prevent the underlayment from being contaminated by impurities in the air. Preferably, the width of the upper layer glue-coated paper is identical to the width of the lower layer glue-coated paper, and the upper layer glue-coated paper and the lower layer glue-coated paper are pre-adjusted, so that a coincidence position of the upper layer glue-coated paper and the lower layer glue-coated paper are consistent.

Further, a spraying temperature of the hot melt

Further, a thickness of the hot melt adhesive on the upper surface of the lower layer glue-coated paper is at a range of 0.1-0.15 mm; wherein a thickness of back adhesive sprayed is related to the thickness of the substrate, and the thickness of the back adhesive sprayed does not exceed 10% of the thickness of the substrate.

Further, the hot melt adhesive is sprayed at a temperature of from 170° C. to 180° C.; wherein the temperature of the hot melt adhesive is controlled by a melt tank of the hot melt adhesive machine.

Further, a spray flow rate of the hot melt adhesive is at a range of 380-400 g/min, a spray rate of the hot melt adhesive is at a range of 2.8-3.2 m/min; both the spray flow rate and spray speed of the hot melt adhesive are controlled by a spray cutting head of the hot melt machine to ensure high adhesion between the back adhesive and the underlayment.

Compared with the conventional art, beneficial effects of the present invention are as follows. The present invention by spaying hot melt adhesive on the upper surface of the lower layer glue-coated paper and by adhering the upper surface of the lower layer glue-coated paper by the hot melt adhesive machine, the hot melt adhesive between the lower layer glue-coated paper and the underlayment forms the back adhesive. The process of the present invention increases adhering firmness of the underlayment and the back adhesive, and prevents the underlayment from detaching from the back adhesive during the grinding work of the polishing pad. Thereby, the polishing pad is prevented from being separated from the machine table, and the quality stability of the polishing pad is improved, thereby improving the stability of the polishing process and ensuring high qualified yield of the product.

These and other objectives, features, and advantages of the present invention will become apparent from the following detailed description, the accompanying drawings, and the appended claims.

### BRIEF DESCRIPTION OF THE DRAWINGS

The FIGURE is a diagram showing results of an adhesion test of a comparative example 1 and the example 1 of the present invention.

### DETAILED DESCRIPTION OF THE PREFERRED EMBODIMENT

In order to further understand the present invention, the process and effects of the present invention is illustrated in detail combing with the preferred embodiments of the present invention.

In the embodiments, the type of the hot melt adhesive machine is JYT110; the hot melt adhesive is M adhesive and the type is 5065HG.

### EXAMPLE 1

(1) Before spraying back adhesive, checking size, thickness and cleanliness of an underlayment, an upper-layer glue-coated paper, a lower-layer glue coated paper; wherein the width of both the upper-layer glue coated paper and the lower-layer glue coated paper is 1.5 m, a thickness of an ejector nozzle is 1 m, a width of the underlayment is 0.8 m;

(2) setting a temperature of both a cutting head of a coating machine and a melt tank at 175° C.;

(3) respectively adjusting the upper-layer glue-coated paper of an upper conveying roller and the lower-layer glue-coated paper of a lower conveying roller, so as to coincide the upper-layer glue-coated paper and the lower layer glue-coated paper; adjusting a tension of the upper-layer glue-coated paper and the lower-layer glue-coated paper through an operation interface of the hot melt adhesive machine; wherein an up tension is at a range of 11%-17%; a rear tension is at a range of 28%-35%; furthermore, adjusting a spraying flow of the hot melt adhesive to 390 g/min and a spraying rate of the hot melt adhesive to 3 m/min; and

(4) checking whether a thickness of a coating layer reaches 0.12 mm, if yes, starting spraying hot melt adhesive.

### EXAMPLE 2

(1) Before spraying back adhesive, checking size, thickness and cleanliness of an underlayment, an upper-layer glue-coated paper, a lower-layer glue coated paper; wherein the width of both the upper-layer glue coated paper and the lower-layer glue coated paper is 1.5 m, a thickness of an ejector nozzle is 1 m, a width of the underlayment is 0.8 m;

(2) setting a temperature of both a cutting head of a coating machine and a sol tank at 170° C.;

(3) respectively adjusting the upper-layer glue-coated paper of an upper conveying roller and the lower-layer glue-coated paper of a lower conveying roller, so as to coincide the upper-layer glue-coated paper and the lower layer glue-coated paper;

adjusting a tension of the upper-layer glue-coated paper and the lower-layer glue-coated paper through an operation interface of the hot melt adhesive machine; wherein an up tension is at a range of 11%-17%; a rear tension is at a range of 28%-35%; furthermore, adjusting a spraying flow of the hot melt adhesive to 380 g/min and a spraying rate of the hot melt adhesive to 3.2 m/min; and

(4) checking whether a thickness of a coating layer reaches 0.1 mm, if yes, starting spraying hot melt adhesive.

### EXAMPLE 3

(1) Before spraying back adhesive, checking size, thickness and cleanliness of an underlayment, an upper-layer glue-coated paper, a lower-layer glue coated paper; wherein the width of both the upper-layer glue coated paper and the lower-layer glue coated paper is 1.5 m, a thickness of an ejector nozzle is 1 m, a width of the underlayment is 0.8 m;

(2) setting a temperature of both a cutting head of a coating machine and a sol tank at 170° C.;

(3) respectively adjusting the upper-layer glue-coated paper of an upper conveying roller and the lower-layer glue-coated paper of a lower conveying roller, so as to coincide the upper-layer glue-coated paper and the lower layer glue-coated paper; adjusting a tension of the upper-layer glue-coated paper and the lower-layer glue-coated paper through an operation interface of the hot melt adhesive machine; wherein an up tension is at a range of 11%-17%; a rear tension is at a range of 28%-35%; furthermore, adjusting a spraying flow of the hot melt adhesive to 400 g/min and a spraying rate of the hot melt adhesive to 2.8 m/min; and

(4) checking whether a thickness of a coating layer reaches 0.15 mm, if yes, starting spraying hot melt adhesive.

### COMPARATIVE EXAMPLE

(1) Before spraying back adhesive, checking size, thickness and cleanliness of an underlayment, an upper-layer glue-coated paper, a lower-layer glue coated paper; wherein the width of both the upper-layer glue coated paper and the lower-layer glue coated paper is 1.5 m, a thickness of an ejector nozzle is 1 m, a width of the underlayment is 0.8 m;

(2) setting a temperature of both a cutting head of a coating machine and a sol tank at 175° C.;

(3) respectively adjusting the upper-layer glue-coated paper of an upper conveying roller and the lower-layer glue-coated paper of a lower conveying roller, so as to coincide the upper-layer glue-coated paper and the lower layer glue-coated paper; adjusting a tension of the upper-layer glue-coated paper and the lower-layer glue-coated paper through an operation interface of the hot melt adhesive machine; wherein an up tension is at a range of 11%-17%; a rear tension is at a range of 28%-35%; furthermore, adjusting a spraying flow of the hot melt adhesive to 390 g/min and a spraying rate of the hot melt adhesive to 3 m/min; and

(4) checking whether a thickness of a coating layer reaches 0.12 mm, if yes, starting spraying hot melt adhesive.

1. Viscosity Test

Experimental method: peel strength test by 180 degrees.

Experimental equipment: intelligent electronic tensile testing machine.

Experimental materials: products of Comparative Example 1 and Example 1 were randomly selected and divided into five groups.

Experimental procedure: take a sample to be tested with a size of about 20×30 cm; punch to sample the sample to be tested by a punch, and use a 125×12.7 mm mold for sampling, 2 or 3 sampling strips are punched in each group; the separate the sampling strips from the underlayment and back adhesive to ensure that at least 5cm of the sampling strip is not torn away; open a software of TESTERPRO system to be connected with a tensile machine, confirm a sensor 200 Kg is connected, click the peeling option on the main interface, which is a standard method, set a force sensor to 200Kg in the configuration, other conditions unchanged, the peeling speed is 200 mm/min, respectively clamp the two ends of pre-separated sampling strips at two ends of a clamp, and adjust the position of the clamp to make the sampling strip straight; click all clear and click start, when the sampling strip is completely peeled off, the tension machine automatically stops and the clamp returns to a starting position. Record a maximum value, a minimum value and an average value at this time; record a model and a batch number of the back adhesive tested and a width of the sampling strip, wherein the width of the sampling strip is 12.7; click report-internal report-exporting excel-logging data. The results are shown in Table 1 and the FIGURE. Table 1 shows the results of the adhesion test of the Comparative example 1 and the Example 1.
A—Directly adhering M glue with a model number of 5065HG on an underlayment Q
B—Sparying hot melt adhesive on the underlayment Q and then adhering M glue

| | A | | | | | |
|---|---|---|---|---|---|---|
| | Maxi- | | | B | | |
| | mum | Minimum | Average | Maximum | Minimum | Average |
| | force | force | force | force | force | force |
| First | 0.8927 | 0.6480 | 0.7490 | 1.7302 | 1.3988 | 1.5985 |
| group | 1.0550 | 0.7605 | 0.9348 | 1.5821 | 1.2161 | 1.3985 |
| | 0.7686 | 0.5175 | 0.6226 | 1.5685 | 1.3039 | 1.4384 |
| Second | 0.9620 | 0.6661 | 0.7765 | 2.4065 | 1.3416 | 1.8100 |
| group | 0.9159 | 0.5258 | 0.7857 | 1.9449 | 1.5666 | 1.7736 |
| Third | 0.8435 | 0.5973 | 0.7133 | 2.7183 | 1.3216 | 1.8375 |
| group | 0.8005 | 0.4899 | 0.6867 | 2.2309 | 1.1937 | 1.6852 |
| | | | | 2.4030 | 1.8305 | 2.1203 |
| Fourth | 0.7789 | 0.4561 | 0.6235 | 2.2668 | 1.8450 | 2.0102 |
| group | 1.1207 | 0.4840 | 0.8082 | 2.1523 | 1.5955 | 1.8307 |
| | | | | 2.7071 | 1.5950 | 1.9291 |
| Fifth | 1.0289 | 0.8124 | 0.9078 | 2.2785 | 1.7153 | 1.9310 |
| group | 0.9095 | 0.7027 | 0.7955 | 2.5378 | 1.8320 | 2.1296 |
| | | | | 2.5332 | 1.6853 | 2.1131 |

According to the data in the Table 1 and the FIGURE, the viscosity between the underlayment and the back adhesive of products obtained by hot melt adhesive spraying is apparently stronger than products obtained by directly adhering.

2. Terminal Test on Machine

The product produced in the Example 1 is made into a polishing pad to be tested on the terminal. The test results show that the polishing process is norma and there is no problems of water seepage or degumming.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A process for spraying back-adhesive of a chemical mechanical polishing (CMP) pad, comprising steps of: horizontally placing an underlayment on middle portions of an upper conveying roller and a lower conveying roller of a hot melt machine for feeding;
providing an upper layer glue-coated paper closely attached with an upper surface of the underlayment on the upper conveying roller, providing a lower layer glue-coated paper closely attached with a lower surface of the underlayment on the lower conveying roller;
spraying hot melt adhesive on an upper surface of the lower layer glue-coated paper via an ejector nozzle of the hot melt machine; wherein the upper layer glue-coated paper, the underlayment and the lower layer glue-coated paper are transmitted and adhered with each other on the upper conveying roller and the lower conveying roller.

2. The process as recited in claim 1, wherein a width of the upper layer glue-coated paper and a width of the lower layer glue-coated paper are both greater than a width of the ejector nozzle, and the width of the ejector nozzle is greater than a width of the underlayment.

3. The process as recited in claim 1, wherein a thickness of the hot melt adhesive on the upper surface of the lower layer glue-coated paper is at a range of 0.1-0.15 mm.

4. The process as recited in claim 1, wherein the hot melt adhesive is sprayed at a temperature of from 170° C. to 180° C.

5. The process as recited in claim 1, wherein a spray flow rate of the hot melt adhesive is at a range of 380-400 g/min.

6. The process as recited in claim 1, wherein a spray rate of the hot melt adhesive is at a range of 2.8-3.2 m/min.
